(19) United States
(12) Patent Application Publication
(10) Pub. No.: US 2018/0054429 A1
(43) Pub. Date: Feb. 22, 2018

(54) SYSTEMS AND METHODS FOR THE DETECTION AND CONTROL OF ACCOUNT CREDENTIAL EXPLOITATION

(71) Applicant: Seklarity Corporation, Woodinville, WA (US)

(72) Inventor: Joseph Jude Donahue, Woodinville, WA (US)

(21) Appl. No.: 15/631,749

(22) Filed: Jun. 23, 2017

Related U.S. Application Data
(60) Provisional application No. 62/376,814, filed on Aug. 18, 2016.

(51) Int. Cl. H04L 29/06; G06F 21/55

(52) U.S. Cl. CPC H04L 63/08; H04L 63/1475; H04L 63/1416; H04L 2463/144; H04L 63/1408; G06F 21/55

(57) ABSTRACT

The present system and method are directed to the detection of access paths in a computer network that malicious actors can exploit. A credential security discovery system receives information about computer accounts and computer account credentials and credential artifacts from computer devices. Additionally the credential security discovery system derives information about the permissions and rights of these accounts across a network of computing devices, such as computers and computing systems. The credential security discovery system then evaluates the ability for malicious actors to access and exploit these artifacts to gain access to additional computing devices. In this way the owners and administrators of the computer devices are aware of the total impact of account compromise, for example, via credential theft, from one or more computing devices across all of their computer devices and across their network. The credential security discovery system can then interact with the computer devices to remove credentials and credential artifacts.

### CROSS-REFERENCE

This application claims the benefit of U.S. Provisional Application No. 62/376,814, filed Aug. 18, 2016, the disclosure of which is incorporated herein by reference in its entirety.

### BACKGROUND OF THE INVENTION

Computer accounts are a computer configuration which allows many users to use a computing device, or many computing devices. The computing devices can keep the data of each user separate from the data of each other user based on assigning different users different computer accounts. The computing devices keep and enforce a set of rights, or permissions, for each user to isolate data and isolate administrative duties according to the set of rights and permissions.

In order for computing devices to enforce data rights between different users, a computing device stores information about the user in order to authenticate that a user is associated with a particular account. This information is typically a shared secret like a password or algorithmic hash of a password, or a digital representation of a biometric characteristic like a fingerprint, facial scan, or retinal scan. This information for a specific user is commonly called a user credential, or just credentials.

When a user authenticates his or her identity with the computing device, the computing device creates artifacts of the authentication so that as the user continues to interact with the computer device the user does not need to re-authenticate. For example, a user can enter a password such as “mypassword,” and the computer will turn this into a string of numbers and letters such as “91dfd9ddb4198affc5c194cd8ce6d338fde470e2,” which, depending on the method the computers uses, could be a hash of the password. The computer may only store the hash of the password and not the actual password to check to see if the user entered the correct password. These hashes are a common example of what is commonly called a credential artifact.

In a multi-computer device system, for example a network of computers administered by a single or related entity which is designed to allow users to access multiple computer devices, the computer device can create additional artifacts designed to allow a user authenticated to a single device to be authenticated to an additional device without additional action from the user. This capability is typically known as single sign-on. For example, in some single sign-on systems the hash stored by the single computing device in the example discussed above can be stored in a way that multiple computing devices have access to this hash. Then when the user attempts to authenticate to another computing device, such as an email server, the computing device that the user already logged into can send the hash of the password that the user entered to a second computing device which can also compare the hash to the stored copy of the hash. If they match, the user will be authenticated without having to re-enter a password. In this example these hashes are also commonly known as credential artifacts. Examples of these artifacts are web-site tokens, password hashes, kerberos tickets, and digital certificates.

Computer devices associate these artifacts with individual users and store them for the duration of a computer session, or across multiple computer sessions. Computer applications are able to create and store these artifacts in a computing device to provide a better user experience like the single sign-on experience described above in which the user only entered a password once, but was able to access multiple computing devices. In order to deliver a single sign-on experience computing devices can store credentials or credential artifacts in the computing device for long durations (e.g., months) across multiple user sessions and computer power-off cycles.

A common attack of malicious actors is to gather these artifacts from computing devices and authenticate to computing devices with these credential artifacts as different users. An example is when a malicious actor searches the memory of a computing device for the list of users and their credentials and credential artifacts. The malicious actor takes the results of this searching and runs application, like an email application with the account name of another user. This is commonly called credential theft or impersonation. Malicious actors can obtain these credentials in many ways, from guessing user-entered passwords, to employing lists of common passwords in attempts to authenticate, to retrieving hashes, tokens, or tickets from the active memory of the computing device, or running key logging software which captures credentials when entered.

In addition to impersonating a user on a single computing device as described above, once a malicious actor obtains credential artifacts from one computing device, he or she is able to use these artifacts to authenticate to additions computer devices as described above. At each new computing device, the malicious actor has the opportunity to search for and collect additional credentials on that device. This is commonly known as “lateral transversal” of a computer network.

As malicious actors harvests more credentials, they have the opportunity to harvest a credential which has increased rights on the computer network, for example the credentials or credential artifacts of a user who has increased access privileges, such as an email administrator on other computing devices on a network. This is commonly known as “privilege escalation”.

Through continued lateral transversal and privilege escalation, malicious actors are able to control the access to the resource on the network and gain access to valuable information.

Currently, owners and administrators of computer networks use signature-based anti-malware software to detect the user of credential theft malware, or analysis of computer events to detect when a computing device has been exploited, credentials have been retrieved (i.e., “stolen”), or lateral transversal is being executed (by analyzing authentication “events”).

Many owners and administrators of computer networks employ the collection of user authentications, commonly called “logon events”, and attempt to build a behavioral model of logon events to look for anomalous authentications.

### SUMMARY OF THE INVENTION

Owners and administrators do not have complete knowledge of the credential artifacts on the computing devices in their networks. This can lead to gaps in their security, making their systems vulnerable to exploitation through lateral traversal and privilege escalation. For example, a logon event may capture the fact that a user authentication occurred, but does not indicate whether there are credentials or credential artifacts residing on a device at some future time. Owners and administrators also do not have knowledge of whether or not a computing device is compromised, what credentials are available to the attacker that has access to a particular computing device, and where can those credentials be used to gain access more information, such as additional credentials or sensitive information.

A method and system are disclosed herein that can detect the existence of credentials and credential artifacts residing on computing systems, and the paths that attackers can take from one computing device to another using compromised credentials based on the rights of the credentials and their ability to retrieve additional credentials on additional computing devices, sometimes called harvesting. The present disclosure is also directed to removing credentials and credential artifacts from computing devices in a way which will not significantly disrupt the users of the respective computing devises and of the network.

In one embodiment a credential security discovery system extracts current credentials, current credential state, and current credential artifacts from different computing devices. The system also collects information about each computing device's accounts rights configuration, such as a list of computing devices which an account has access to credentials or credential artifacts, as well as settings, such as settings that control how credentials and credential artifacts are stored which can affect the availability of credentials and credential artifacts to malicious actors. The credential security discovery system then evaluates the information from each computer device, and determines which credentials can be used to access other computing devices and have the required rights to extract additional credential and credential artifacts on other computer devices. The results of the evaluation include information relating to which credentials are available to attackers, and on which other machines those credentials can be used. The credential security discovery system then performs behavioral analysis based on the collected information. For example the credential security discovery system may determine the time of an authentication, the type of authentication (e.g., interactive, or system), the user name associated with the authentication, and the application used (e.g., a part of the operating system, or one that connects to another network). The results of the behavioral analysis are used to identify which sets of credential and/or credential artifacts are able to be removed from which computing devices without disrupting user interaction, for example causing a computing device to stop operations, or a user to need to re-enter passwords. The system then sends information to the user device regarding which credentials and credential artifacts should be remediated (adjusted or removed).

In yet another embodiment, a method for discovering credentials and credential artifacts on a computing device is disclosed. The method includes querying the computer device operating system for credentials and credential artifacts which the operating system is storing, typically in a local security system.

A method for analyzing credential information to present to owners and administrators which credentials and credential artifacts are available on a computing device for attackers to collect is also disclosed. A common example might be that an account name with a clear-text password is available on a computing device.

A method for analyzing user and system behavior relating to authentications and credential/credential artifact storage and use is disclosed. The system includes a web services component of the credential discovery system that receives behavioral information about credential and credential artifacts from different user devices. The system further includes an analysis engine of the credential discovery system that determines the risk involved with and reasons for any computing device to store the credential or credential artifact based on the behavioral information received from each of the different user devices.

A method for adjusting or removing credentials or credential artifacts from a device is disclosed.

The above and other features including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features disclosed herein may be employed in various and numerous other embodiments without departing from the scope of the invention.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

In the accompanying drawings, reference characters refer to the same parts throughout the different views.

FIG. 1 is a block diagram illustrating a distributed security system for the detection and control of account credential exploitation risk in accordance with one or more embodiments described herein.

FIG. 2 is a block diagram illustrating a credential discovery system software architecture implemented in accordance with one or more embodiments described herein.

FIG. 3 is flow diagram illustrating a process for the detection and control of account credential exploitation in accordance with one or more embodiments described herein.

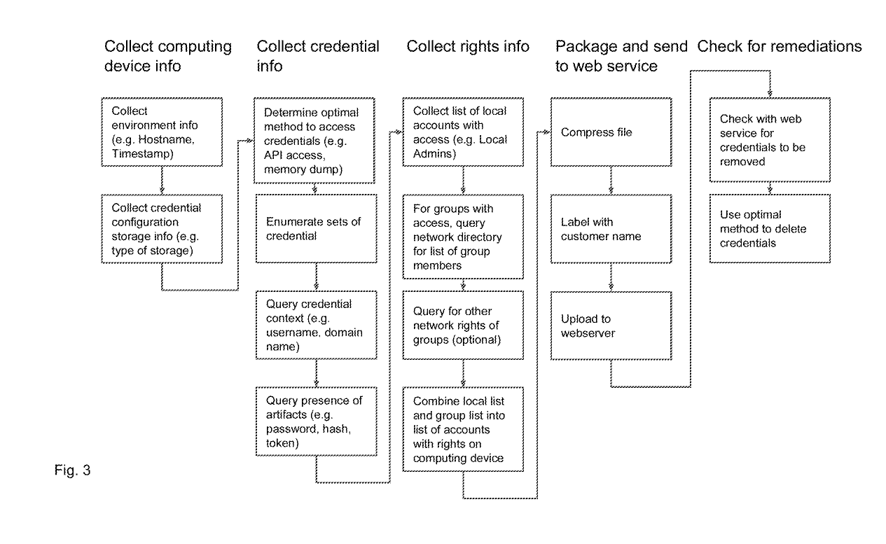

FIG. 4 is flow diagram illustrating a process for the detection and control of account credential exploitation in accordance with one or more embodiments described herein.

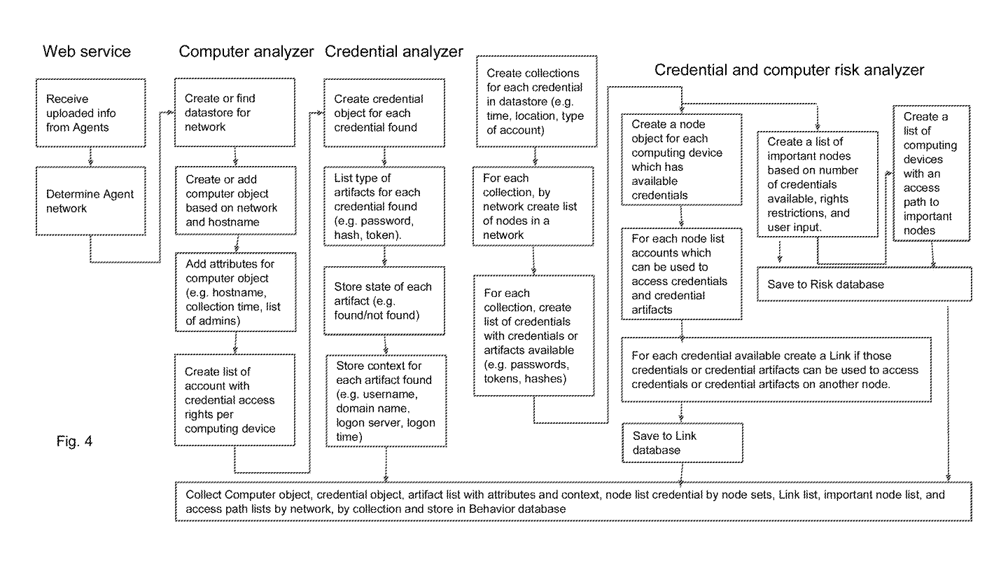

FIG. 5 is a flow diagram illustrating a process for the detection and control of account credential exploitation in accordance with one or more embodiments described herein.

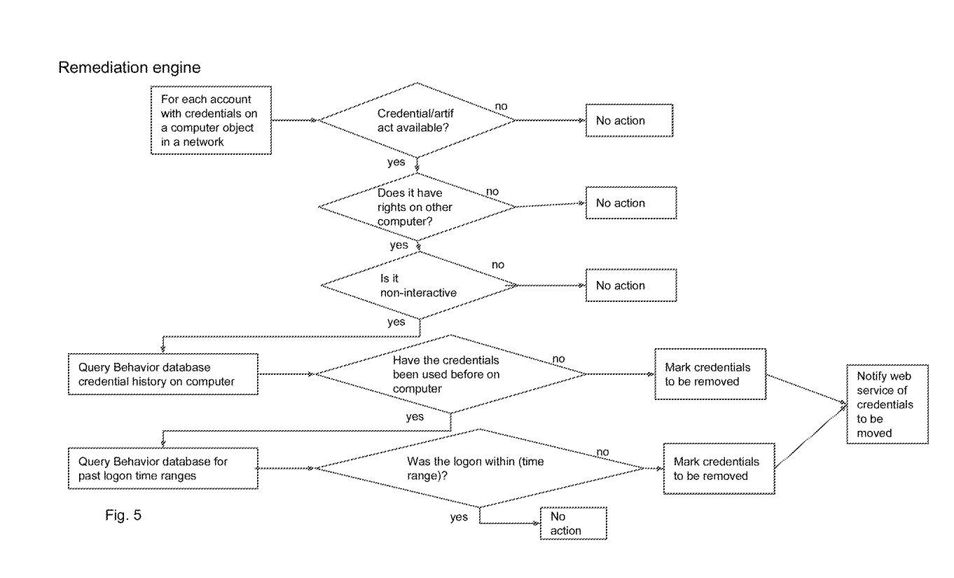

### DETAILED DESCRIPTION OF THE INVENTION

In general, a distributed security system 100 includes one or more user computing devices, for example computing devices 101-1, 101-2, 101-3 which each includes a credential security discovery system agent (Agent) that is in communication with a credential security discovery system service (Service) 102 via a private and/or public network. The agent collects information from the computer devices as well as any related security systems, such as a network user database, and sends information to the credential security discovery system service.

In some embodiments, the Agent collects one or more of accounts, rights, credentials, credential artifact, and the state of the credentials.

In some embodiments the Agent may directly query the local security manager associated with one or more of the computing devices 101-1, 101-2, 101-3. In doing so, the Agent may search the memory space of the local security manager, collect a memory dump, of the local security manager (which may include a copy of the memory being used by a program), search files, or use another method of determining which credential and credential artifacts the computing device is currently storing and using to operate.

In some embodiments the Agent also may query computer configuration information such as hostname, local accounts, or computing device role. The agent may also search a computing device's local configuration files, such as registry files, user profile information, or computer profile information. The computing devices can include workstations, application servers, database server, directory servers, web servers, or any servers which users or administrators have access.

In some embodiments, the Agent also may query the computing device's local security manager, search the memory space of the local security manager, search a memory dump of the local security manager, or search for files that contain information about user account credentials and credential artifacts in order to determine what credential information is available to malicious actors. The Agent also searches and collects information to determine on which other computing devices accounts available to malicious actors can be used. This searching and collecting may also include querying the computer configuration or the network configuration such as an organization wide device and/or account directory or database, or any method of determining the rights which relate to credential exploitation that accounts have on other computing devices.

The rights relating to credential exploitation may include local administrative rights on a computing device or access to memory or APIs relating to credential and/or credential artifacts. Local administration rights on a computing device may include rights to access all memory locations and all APIs, so local administrative rights may provide access to all credentials and credential artifacts. More granular rights on some accounts may also provide this access.

In some embodiments, the Agent sends this collected information to the Service via a web service 102-1.

In some embodiments, the Service will then analyze the collected information using an analysis engine 102-2 and organize it into databases 102-3.

In some embodiments, the Service identifies remediation actions, such as removal of credential and/or credential artifacts, prohibiting and/or modifying credential usage on computing devices, or modifying credential rights on computing systems using a remediation engine 102-4. In some embodiments, these remediation actions make the system more secure are by reducing the number of accounts that can be impersonated on each computing device or by regularly removing the credentials or credential artifacts for accounts with the most important rights, such as administrative rights, from computing devices at a frequency that is greater than the frequency of removal of the credentials or credential artifacts for accounts with the less important rights, such as local user right.

In some embodiments, the Service will send the remediating actions to the Agent for execution.

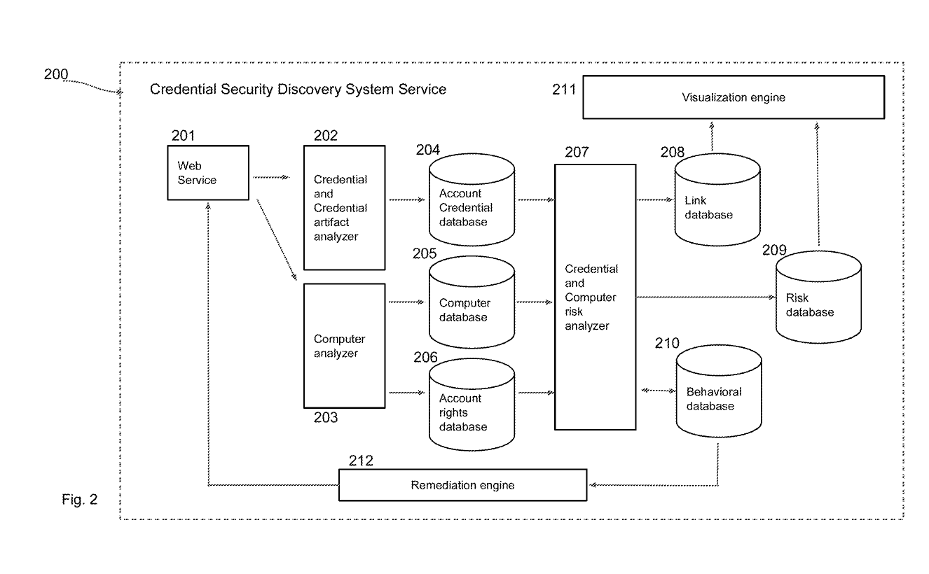

FIG. 2 is a block diagram of the credential security discovery system service (Service) software architecture that is implemented in the cloud, such as on a server computing device.

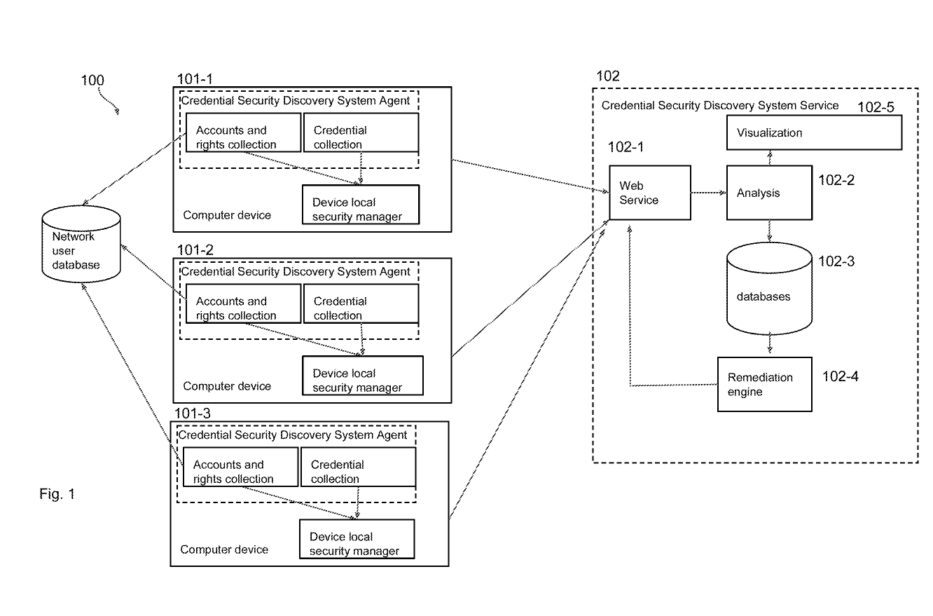

The System Web Service 201 is responsible for communicating with the Agents, for example the Agents shown in FIG. 1. The Web Service receives collected information and forwards the information to a Credential and Credential artifact analyzer 202 and/or a Computer analyzer 203.

The Credential and Credential artifact analyzer examines the credential and credential artifact information and determines which accounts have credential information present on each of the computing devices and what credential or credential artifact information, such as username, passwords, password hashes, tickets, or tokens, is present on the computer devices. The Credential and Credential artifact analyzer may also search credential artifacts for common artifacts across different accounts, or type of credential, such as for a web-site, for a network, for a specific authentication package like kerberos, terminal services, or single-sign on packages. An example of a common credential is the same password being used on different applications. This information may be stored by the local security manager on the device from which the information was collected, or may need to be derived, by searching and comparing many artifacts from other credential artifact information like the username or domain name of the credential.

The Credential and Credential artifact analyzer then stores the results of the analysis on the Account Credential database 204.

The Computer Analyzer determines which accounts can be used on which systems to access credential and credential artifact information. For example, the Computer Analyzer may analyze the local accounts on each computing device and compare with the account rights information collected to generate a list of accounts which have access to credential and credential artifacts on other computing devices. In some embodiments, the Computer analyzer stores a list of computing devices in a network with information such as role, local accounts, and name in the Computer database 205 and for each computing device a list of user accounts which have rights to allow access to credentials and credential artifacts on that computing device in the Account rights database 206.

In the illustrated example, the Credential and Computer risk analyzer 207 queries the information in the Account Credential database, the Computer database, and the Account rights database to determine risks of credential exploitation. These queries can include queries for accounts found on a computing device, queries regarding which accounts have credentials or credential artifacts available, queries for which other computing devices these accounts have access, and queries of what information is available on the other computing devices. Typical risks include the presence of credentials and credential artifacts on computing devices. The risks can be scored based on quantitative measures such as the prevalence of these accounts on multiple computing devices, and the rights of these accounts with more rights indicating a higher risk. In some embodiments, a list is constructed of accounts with clear text passwords available to attackers, or accounts likely to be compromised based on a high frequency of occurrence on multiple computer devices. The Credential and Computer risk analyzer will store accounts which have credentials and credential artifacts available to be collected in the risk database 209.

As described above, the Credential and Computer Risk analyzer can also search for and store information regarding the presence of account credentials or credential artifacts on any computing device that can be can be used to gain access to additional computing devices where additional credentials or credential artifacts can be collected. The Credential and Computer Risk analyzer creates Links for each account with credential or credential artifacts on a computer which can be used to access another computer and collect credentials and credential artifacts. This Links include a Source Node representing the computing device where initial credential and credential artifacts are collected, the Link name which is an account with can be used to access another computing device, and the Target Node representing the computing device on which the initial credential and credential artifacts can be used to collect additional credential and credential artifacts. The Links can be stored in a Link database 208, and could optionally be visualized by a visualization engine 211 for example in a graph diagram displaying nodes and links.

Additionally the Credential and Computer risk analyzer can store information about credentials and credential artifacts in the behavioral database 210. The database may include information such as the time of logon for credentials, the logon server, the type of logon, for example interactive or computing device to computing device, frequency of credential sessions, duration of credential sessions, common credentials in an environment based on operating systems, system accounts configured, or accounts configured by administrators, or process owned and launched by accounts.

The remediation engine 212 can analyze the behavioral database and determine which credentials and credential artifacts can be removed from systems without negatively impacting system user. For example, the remediation engine can determine that an account named “back-up service account” performs non-interactive authentications once every 24 hours, then launches a single process which completes in 5 minutes, but leaves credential artifacts on the computing device. The remediation engine determines that based on factors which indicate times that an account is not actively being used by the computing device, for example frequency of authentication, non-interactive logon, single consistent process creation, and duration of process; these credentials and credential artifacts can safely be removed from the computing device and send a message to the Web Service which notifies the Agent which deletes the credentials and credential artifacts.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of protecting a computer network comprising:
receiving credentials or credential artifacts of one or more accounts from one or more computing machines by querying the one or more computing machines on a computer network;
receiving the access rights associated with the credentials or credential artifacts of the one or more accounts;
determining, for each of the credentials or credential artifacts received from a first of the one or more computing devices, a first credential or credential artifact that includes access rights to a second credential or credential artifact on one or more computing devices; and
removing the first credential or credential artifact from the first of the one or more computing devices based on a usage of the first credential or credential artifact on the first of the one or more computing devices.

2. The method of claim 1, further comprising:
receiving behavioral information regarding the usage of each of the credentials or credential artifacts on each of the one or more computing machines.

3. The method of claim 2, wherein the removing the first credential or credential artifact includes:
determining, based on the behavioral information, whether the first credential or credential artifact has even been used on the first of the first of the one or more computing devices; and
removing the first credential or credential artifact on the first of the one or more computing devices if the first credential or credential artifact has never been used on the on the first of the one or more computing devices.

4. The method of claim 2, wherein the removing the first credential or credential artifact includes:
determining, based on the behavioral information a time since the first credential or credential artifact was last used on the first of the first of the one or more computing devices; and
removing the first credential or credential artifact on the first of the one or more computing devices if the time is greater than a predetermined time.

5. The method of claim 1, further comprising:
receiving credential configuration storage information by querying each of the one or more computing machines.

6. The method of claim 5, further comprising:
determining the credential access methods on each of the one or more computing devices based on the credential configuration storage information from each of the one or more computing devices.

7. The method of claim 1, further comprising:
determining which of the one or more accounts have access rights to each of the one or more computing machines.

8. The method of claim 7, wherein the determining, for each of the credentials or credential artifacts received from the first of the one or more computing devices, the first credential or credential artifact that includes access rights to the second credential or credential artifact on one or more computing devices, is based on which of the one or more accounts have access rights to each of the one or more computing machines.
